(19) United States
(12) Patent Application Publication
(10) Pub. No.: US 2024/0339645 A1
(43) Pub. Date: Oct. 10, 2024

(54) FUEL CELL STACK, AND FUEL CELL SYSTEM HAVING A FUEL CELL STACK

(71) Applicant: CELLCENTRIC GMBH & CO. KG, Kirchheim/Teck-Nabern (DE)

(72) Inventors: Philipp HAUSMANN, Kirchheim/Teck-Nabern (DE); Matthias FEUERBACH, Kirchheim/Teck-Nabern (DE)

(21) Appl. No.: 18/294,383

(22) PCT Filed: Aug. 17, 2022
(86) PCT No.: PCT/EP2022/072979

§ 371 Date: Feb. 1, 2024

(30) Foreign Application Priority Data
Aug. 18, 2021 (DE) 10 2021 209 034.6

(51) Int. Cl. H01M 8/2457; H01M 8/04119; H01M 8/04746

(52) U.S. Cl. CPC H01M 8/2457; H01M 8/04126; H01M 8/04761

(57) ABSTRACT

The invention relates to a fuel cell stack with a plurality of individual cells, wherein the individual cells have a common cathode region and a common anode region that is separate from the common cathode region. The fuel cell stack according to the invention is characterized in that at least one valve device is integrated for blocking the flow path into the cathode region and/or out of the cathode region.

The invention relates to a fuel cell stack with a plurality of individual cells, with a common cathode region and a common anode region, and a fuel cell system with a fuel cell stack. The invention relates in particular to a fuel cell stack with a plurality of individual cells, wherein the individual cells have a common cathode region and a common anode region separated from the common cathode region, as well as a fuel cell system with a fuel cell stack.

Fuel cell stacks consisting of a plurality of individual cells are known in principle from the prior art. Typically, the individual cells are clamped between two end plates and a common cathode region and a common anode region are formed for all individual cells of the fuel cell stack. An inflow and outflow region therefore typically extends over the entire length of the stack in the stacking direction and is formed by openings formed in the individual cells, which connect all cells of the fuel cell stack parallel to one another with regard to the flow of gaseous educts.

In practice, fuel cell stacks of this type are now used in fuel cell systems. When designing fuel cell stacks with individual cells using PEM technology, i.e. with a proton-conducting membrane or polymer electrolyte membrane, it happens that when the fuel cell system is started, the gases in the fuel cell system are flushed through the fuel cell stack if fresh gas for the start is added. This is particularly critical for the anode region. If the hydrogen in the anode region has evaporated after the end of operation of the fuel cell stack or has been used up in the fuel cell by atmospheric oxygen flowing in, there is usually air in the anode region. If hydrogen is now added, an air/hydrogen front flows in parallel over all of the individual cells in the fuel cell stack. This, together with air in the cathode region, leads to a critical potential difference on this front, which damages the fuel cell's catalyst. The service life is adversely affected by such a start of the fuel cell stack, also known as air/air start.

To counteract this, hydrogen can now be stored in the anode region, for example, which ideally is not used up during the entire downtime of the fuel cell stack. One of the mechanisms for this is to prevent air from flowing into the cathode region. In fuel cell systems, as those known from the prior art, valve devices are often used to shut off the cathode region of the fuel cell stack when the fuel cell system is at a standstill. These components, also known as cathode blocking valves, are often large valves or flaps that are used in the periphery of the fuel cell stack. They are heavy, prone to failure, sensitive to leaks and, at least if the structure is sufficiently tight, relatively expensive. In addition they require, together with their control electronics and an actuator to control the valve, a relatively large amount of installation space.

The object of the present invention is to further improve a fuel cell stack of the type mentioned in the preamble of claim 1 in order to enable a long service life, and to provide an improved fuel cell system with such a fuel cell stack.

According to the invention, this object is achieved by a fuel cell stack having the features of claim 1, and here in particular the characterizing part of claim 1 and by a fuel cell system having the features of claim 15. Advantageous embodiments and developments result from the corresponding dependent claims.

In the fuel cell stack according to the invention it is provided that it has at least one integrated valve device for blocking the flow path, in particular the flow path of cathode gas, which preferably contains air, into and/or out of the cathode region, in particular into the cathode region and/or out of the cathode region. This integration of a valve device into the interior of the fuel cell stack makes it possible to eliminate such valve devices in the region of the fuel cell system, in particular outside the fuel cell stack, which contributes significantly to saving installation space, in particular for the fuel cell system. A single valve device can already block the flow path through the cathode region accordingly, so that flow through the cathode region is no longer possible. This already ensures a very positive effect, since air can be exchanged in the cathode region only through convection processes from one and the other side of the valve, in particular the valve device.

According to an extremely favorable development of the fuel cell stack according to the invention, the at least one valve device is designed to be integrated into at least one end plate. As already explained above, the individual cells of a fuel cell stack are often clamped together between two end plates. In the region of these end plates, which have a greater thickness than the respective individual cells of the fuel cell stack, there is typically sufficient installation space to be able to integrate a valve device in the manner described. The valve device can, for example, be integrated into a supply air connection and/or an exhaust air connection, in particular by being screwed into the end plate from the connection side of a supply air line and/or exhaust air line to the fuel cell stack.

The at least one valve device can be designed as a normally closed valve device. Such a normally closed valve device ensures that the flow path through the cathode region of the fuel cell stack is sealed without active actuation and without permanent energy requirements. The active actuation for opening can be carried out, for example, by electromagnetic forces, so that the valve devices must be switched intentionally.

Alternatively, it would also be conceivable to provide magnetic forces acting against spring pressure and/or against magnetic, in particular permanent magnetic, forces when a permanent magnet is used in combination with a magnetizable valve body and/or valve seat in order to free the structure from the need of a control.

In particular, the magnetic forces have a very decisive advantage, since they can or are used to form a passive, magnetically degressive valve device. Magnetically degressive means that the valve device is normally kept closed by magnets, wherein the force for keeping it closed is large, and the force which tends to close it again after opening, also known as the closing force, decreases while the opening increases, in contrast to spring-loaded valves where the closing force increases as the opening increases.

In particular, in the normal case, the valve body is held in the valve seat without any flow against the valve seat with a corresponding pressure and/or corresponding flow velocity.

In this state of non-operation, the structure is then sealed and can in particular have one or more seals or one or more sealing elements, which are preferably arranged in the slipstream of the valve body and, on the one hand, ensure a good sealing and in the case of flow do not cause unnecessary pressure losses.

In the case of use of a passive, magnetically degressive valve device, the shut-off function caused by the valve device to block the flow path is particularly pronounced, since the valve body of the valve device is held particularly stably and sealingly in the valve seat by one or more (permanent) magnets in combination with one or more other (permanent) magnets and/or magnetizable regions of the valve body and/or magnetizable regions of the valve seat. This can reduce the number of harmful air/air starts that promote degradation of the fuel cell stack and extend the hydrogen protection time.

If air or cathode gas now actively flows against the cathode region, which gas is supplied via the supply air line and an air supply device, such as one or more flow compressors, compressors or the like, then the pressure and the flow speed of the supplied air ensure that the valve body lifts off from the valve seat against the spring force and/or particularly preferably against the magnetic force and the corresponding valve device thus automatically releases the flow through the cathode region when the air supply is switched on. In particular, magnetic forces of a permanent magnet, which is or can be arranged in the valve seat or at a distance from the valve seat, in combination with a magnetizable valve body can then ensure that a reliable flow through the valve device is possible at different flow volumes. The entire structure is light, robust and, thanks to the use of magnets and the here typical degressive force-path behavior, allows disturbance-free flow both at a minimum flow volume, which is just enough to open the valve device, and at a maximum flow volume. Due to the progressive force-path characteristic of magnets, which is ideal for these flow cases, flow occurs in both cases without a permanent switching between opening and closing of the valve or the valve device, so that pressure pulsations in the cathode region can be reliably prevented and the valve or the valves or the valve device or the valve devices can work efficiently and quietly. This is also known as “chatter-free” operation.

Furthermore, the required installation space can be further reduced by using at least one passive, magnetically degressive valve device, since no additional installation space is required for cabling and/or a control of the same.

The valve body itself can preferably be designed as a soft magnetic part, in particular as a soft magnetic rotating part, or can contain a soft magnetic, in particular magnetizable material and/or a permanent magnet and can preferably be designed with a flow-optimized shape.

According to an extremely favorable development of the fuel cell stack according to the invention, the valve body has an end facing an inlet of the at least one valve device, which in one embodiment has an annular recess or trough, wherein in one embodiment the end of the valve body points upwards when used as intended.

As a result, in one embodiment, any liquid emerging from the cathode region, such as water, can be collected by means of the recess or trough.

According to an extremely favorable development of the fuel cell stack according to the invention, the at least one valve device has a guide device with one or more guide surfaces, which is or are designed to guide an opening or closing movement of the valve body, wherein the guide device has a cylindrical portion, the valve body has at least one projection which extends in the direction of an outlet of the at least one valve device, wherein in one embodiment a central projection of the at least one projection extends into a cavity formed through the cylindrical portion of the guide device and/or a projection of the at least one projection surrounds an end of the cylindrical portion of the guide device facing the inlet of the at least one valve device.

In one embodiment, this can reliably prevent the movement of the valve body from being restricted and/or blocked, for example by jamming.

According to an extremely favorable development of the fuel cell stack according to the invention, an end of the cylindrical portion of the guide device facing away from the inlet of the at least one valve device is closed or has a passage.

As a result, in an embodiment in which the cylindrical portion of the guide device has the passage, any liquid that may be present, such as water, can flow out of the valve device through the passage and then through the valve outlet.

According to an extremely favorable development of the fuel cell stack according to the invention, the at least one valve device has a fixed magnet, which in one embodiment is mounted on the guide device, and a magnet which is mounted on the valve body and is movable together with the valve body, wherein a magnetic force between the fixed magnet and the magnet moving together with the valve body causes the fixed magnet and the magnet moving together with the valve body to attract each other.

In this way, in one embodiment it can advantageously be achieved that the closing force decreases further with increasing opening of the cathode shut-off valve.

Hydrophobic surfaces can be provided in the regions in which the valve body rests against the valve seat during later operation or only small flow cross sections are released between the valve body and the surrounding material. These hydrophobic surfaces can be realized, for example, through suitable surface processing or coating. They can preferably be provided with hydrophilic surfaces in the valve device in order to thus prevent the accumulation of water in the regions important for the actuation of the valve device and at the same time to create regions in which water accumulation can take place uncritically. This makes it possible for inevitable water accumulations in the cathode region of the fuel cell stack, and here in particular in the region of the outflowing medium, to be directed specifically to positions in which they are not critical, even if the water may freeze there.

In this case, the at least one valve device can in particular have regions with a hydrophobic surface, wherein in one embodiment a surface of the valve seat and/or of a sealing element arranged in a region of the valve seat and/or a surface of the valve body is designed to be hydrophobic, wherein the surface of the valve seat and/or of the sealing element faces the surface of the valve body, and/or wherein the guide surface of the guide device and/or an end face of the guide device facing the inlet of the valve device and/or surface portions of the valve body facing the guide device are designed to be hydrophobic. In one embodiment, this can advantageously at least largely prevent the accumulation of liquid, in particular water, on the regions with a hydrophobic surface.

Furthermore, the at least one valve device can in particular have regions with a hydrophilic surface, wherein in one embodiment a surface of the recess and/or a surface of an undercut pointing in the direction of the outlet of the valve device, which is provided on the side of the valve body in a portion of the fuel cell stack in which the valve device is integrated, is designed to be hydrophilic.

In one embodiment, this can ensure that any liquid contained in the cathode gas, such as water, is collected in these regions with a hydrophilic surface and is thus at least temporarily removed from the rest of the fuel cell stack or system. Even if ice forms in these regions due to this accumulation of water due to low temperatures, this has little or no influence on the operation of the valve device, since this does not restrict the mobility of the valve body, as would be the case if the valve body freezes on the valve seat or the sealing element.

According to an extremely favorable development of the fuel cell stack according to the invention, it can be provided that a respective valve device is formed on the upstream and downstream sides of the cathode region. In this particularly favorable development of the fuel cell stack according to the invention, it has two separate valve devices which can shut off the fuel cell stack on the upstream and downstream sides in the event of non-operation, so that the inflow of air can be safely and reliably prevented, be it due to convection effects, wind effects or the like.

According to a further very favorable development of the fuel cell stack according to the invention, it can also be provided that the two valve devices are designed as identical parts. The two valve devices can therefore be designed as identical parts, which makes them more cost-effective in relation to the overall structure, since each of the valve devices is manufactured in larger quantities, which leads to scaling effects. They are then installed within the fuel cell stack with the installation position reversed so that the flow flows through them in the same direction on the inlet and outlet sides.

The fuel cell system according to the invention has a fuel cell stack described above, wherein the fuel cell stack has a valve device arranged downstream of an outlet of the cathode region and integrated into the fuel cell stack, which in one embodiment is designed as a passive, magnetically degressive valve device, and the fuel cell system further has an (active) multi-way valve arranged upstream of the inlet of the cathode region, and a gas jet pump with at least one suction inlet and one drive inlet, wherein an inlet of the multi-way valve is connected with a supply air line of the cathode region, a first outlet of the multi-way valve is connected with the inlet of the cathode region, and a second outlet of the multi-way valve is connected to the drive inlet of the gas jet pump, a suction inlet of the at least one suction inlet of the gas jet pump is connected to an outlet of the cathode region, in one embodiment upstream of the valve device, in a switchable way, in one embodiment by means of a cathode suction valve, and/or another suction inlet of the at least one suction inlet of the gas jet pump is connected to an outlet of the anode region, in one embodiment via a recirculation line connected to the outlet of the anode region, switchable, in one embodiment by means of a purge/drain valve.

This allows any liquids present, such as water, to be drawn, through or after evaporation at low pressure, as well as gases such as air, even at low temperatures, from the volume of the anode region as well as from the volume of the cathode region. In the ideal case, the suction takes place relatively evenly in order to avoid excessive pressure differences between the cathode region and the anode region and thus to protect the membranes.

The disadvantage that cabling is required to control the active multi-way valve is accepted in exchange of the advantage of being able to put the fuel cell stack under negative pressure, which would not be possible with two passive valve devices on the inlet and outlet sides of the cathode region because one of them would always be pressed on.

According to a further very favorable embodiment of the fuel cell system according to the invention, the second outlet of the multi-way valve is connected to an exhaust air line of the cathode region via a cathode bypass line in which the gas jet pump is arranged.

According to a further very favorable embodiment of the fuel cell system according to the invention, the multi-way valve is integrated into a component of the fuel cell system.

In this way, the installation space required for the fuel cell system can be reduced in one embodiment.

According to a further very favorable embodiment of the fuel cell system according to the invention, the system further has a gas/gas humidifier as the component, which is arranged upstream of the inlet to the cathode region, and a gas/gas humidifier bypass line, which is connected upstream of the gas/gas humidifier to the supply air line, and is connected, upstream of the gas/gas humidifier, to an exhaust air line of the cathode region, wherein the multi-way valve is integrated into the gas/gas humidifier, in one embodiment with a humidifier bypass flap of the gas/gas humidifier and/or the gas jet pump is arranged in the gas/gas humidifier bypass line in such a way that the second outlet of the multi-way valve is connected to the drive inlet of the gas jet pump.

Further advantageous embodiments of the fuel cell stack according to the invention also result from the exemplary embodiment, which is represented in more detail hereinafter with reference to the figure.

In particular:

FIG. 1 a fuel cell system in a version according to the prior art,

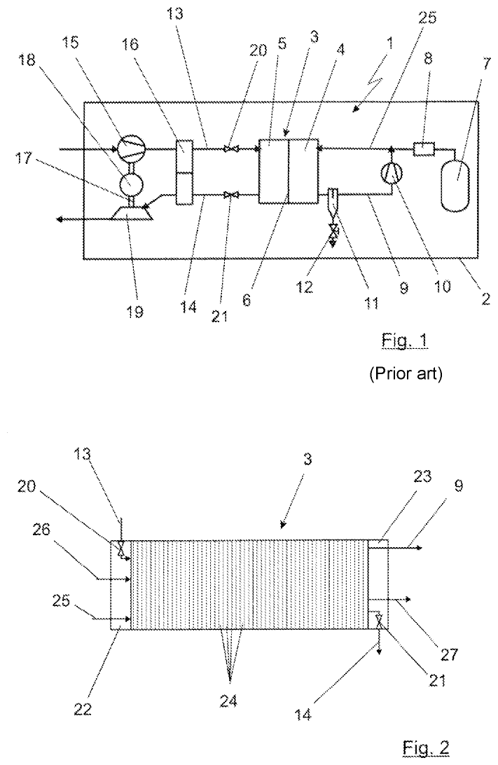

FIG. 2 a fuel cell stack in a possible embodiment according to the invention,

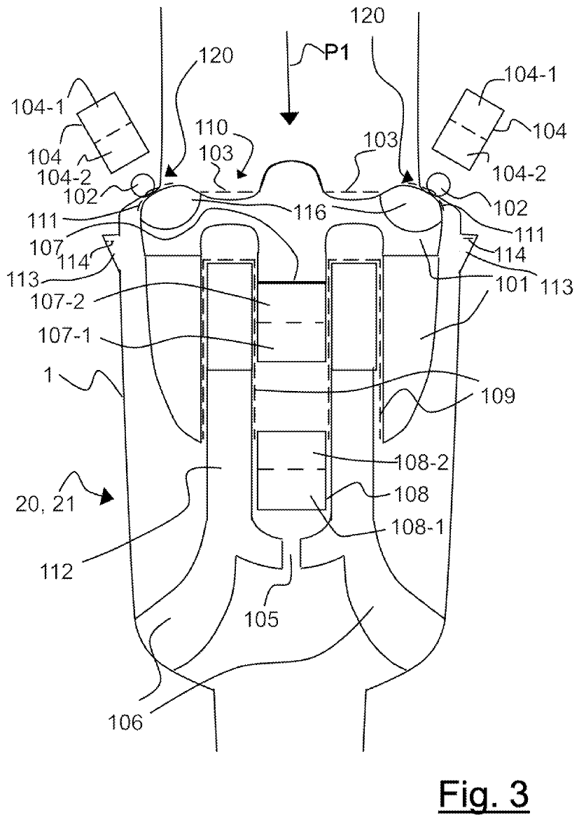

FIG. 3 a valve device for a fuel cell stack in a possible embodiment according to the invention,

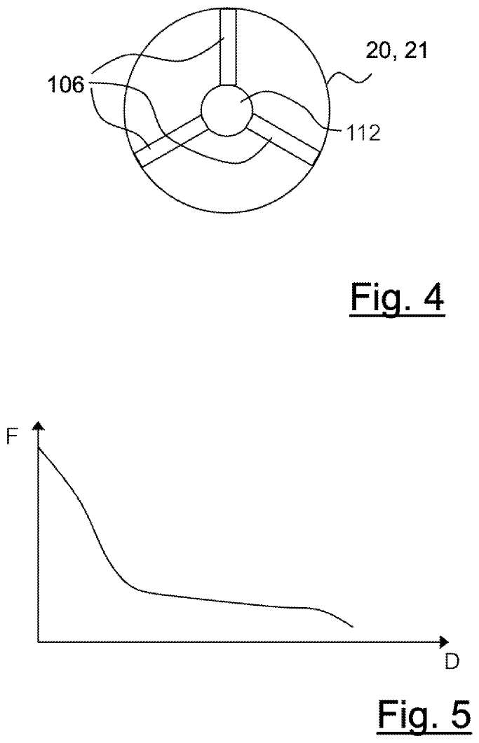

FIG. 4 a top view of a part of the valve device shown in FIG. 3 in the direction of a flow direction,

FIG. 5 a diagram which illustrates the dependence of a closing force of the valve device on an opening degree of the valve device, and

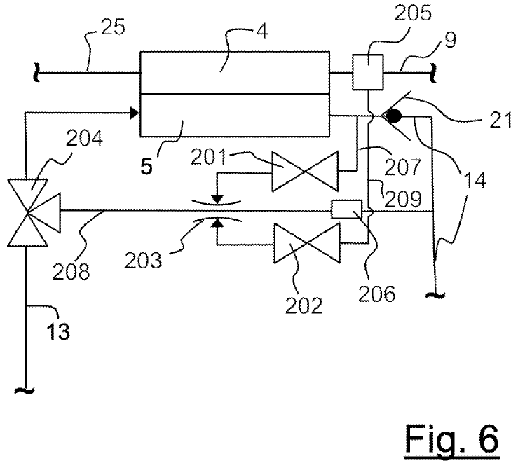

FIG. 6 a schematic view of part of a fuel cell system in a possible embodiment according to the invention.

In the illustration of FIG. 1, a fuel cell system 1 is shown very schematically, which is, for example, intended to be used in a vehicle 2, for providing at least part of the electrical drive power. The core of this fuel cell system 1 is a fuel cell stack 3, which is often also referred to as a fuel cell or fuel cell stack. It typically consists of a plurality of stacked individual cells 24 (see FIG. 2). Purely by way of example, a common anode space 4 or anode region 4 and a common cathode space 5 or cathode region 5 are indicated here, which are separated via a proton-conducting membrane 6. The fuel cell stack 3 is therefore a PEM fuel cell stack.

Hydrogen is supplied to the anode space 4 from a hydrogen source 7, for example a compressed gas storage or a cryogenic storage. This hydrogen reaches the anode space 4 of the respective individual cells via a pressure control and metering unit 8. Unused hydrogen can be returned via a recirculation line 9 with a recirculation conveying device 10, which is here formed, purely by way of example, by a recirculation blower. From time to time, water and the hydrogen can be drained from a water separator 11 and discharged via a purge and drain valve 12.

Air is supplied as an oxygen supplier to the cathode region 5 of the fuel cell system 1 via a supply air line 13. The exhaust air flows from the fuel cell system 1 via an exhaust air line 14. A flow compressor 15 is arranged here to convey the required air. The hot and dry air after the flow compressor 15 reaches the cathode region 5 via a gas/gas humidifier 16 and possibly via a charge air cooler (not shown here). The moist exhaust air from the cathode region 5 in turn passes via the exhaust air line 14 through the gas/gas humidifier 16, in the region of which it releases moisture into the dry and hot supply air and then flows into the environment via an exhaust air turbine 19 in the exemplary embodiment shown here. The exhaust air turbine 19 and the flow compressor 15 are connected to one another via a common shaft 17 and an electrical machine 18 in order to use energy generated in the region of the exhaust air turbine 19 to support the drive of the air conveying device 15, and in the event that this does not require any drive power, to use it as a generator drive of the electrical machine 18.

The fuel cell system 1 according to the prior art now has two cathode shut-off valves 20, 21 in the supply air line 13 as well as in the exhaust air line 14, here purely by way of example between the gas/gas humidifier and the fuel cell stack 3. These cathode shut-off valves 20, 21 are typically designed as actively controlled flaps, which require a comparatively large amount of installation space within the fuel cell system 1 and are correspondingly expensive and complex in terms of assembly and control.

Nevertheless, the effect of such cathode shut-off valves 20, 21 on the service life of the fuel cell stack 3 is positive, since they can prevent fresh air from flowing into the cathode region 5, which ultimately leads to ideally only nitrogen remaining there after a longer standstill of the fuel cell system 1 and no more hydrogen is consumed from the anode region 4 via the fuel cell stack 3 when at a standstill. When the fuel cell system 1 or the fuel cell stack 3 is restarted, an air/air start that is critical for the service life of the fuel cell stack 3 can be prevented.

A schematic representation of the fuel cell stack 3 in a possible embodiment variant according to the invention can now be seen in the illustration in FIG. 2. A plurality of individual cells 24 are clamped between two end plates 22, 23, only some of which are provided with a reference number, and which each have a cathode region 5 or cathode space 5 and an anode region 4 or anode space 4 as well as the membrane 6. The individual anode regions 4 and cathode regions 5 as well as a cooling media flow region, which forms a cooling heat exchanger within the fuel cell stack 3, are connected to one another via openings in the individual cells 24. Hydrogen is supplied to the anode region 4 in the region of the first end plate 22 via a hydrogen supply line 25 and flows out into the recirculation line 9 in the region of the other end plate 23. Furthermore, a cooling media supply 26 in the region of the first end plate 22 and a cooling media discharge 27 in the region of the other end plate 23 can be seen in the illustration in FIG. 2.

The supply air line 13 is connected to the first end plate 22 and the exhaust air line 14 is connected to the second end plate 23. Instead of cathode shut-off valves 20, 21 in the region of the fuel cell system 1, these are now integrated into the fuel cell stack 3, preferably in the respective end plate 22, 23, as indicated schematically here. The end plate 22 therefore carries the cathode shut-off valve 20 on the supply air side, which is a valve device in the sense of this application, integrated into itself, the other end plate 23 carries the exhaust-side cathode shut-off valve 21, which is also a valve device in the sense of this application. Ideally, the cathode shut-off valves 22, 21 integrated into the respective end plates 22, 23 of the fuel cell stack 3 are designed to be passive, i.e., they are normally closed and are pressed open accordingly by the inflowing supply air or the inflowing exhaust air, so that they can be implemented in a simple, efficient way and require minimal installation space within the fuel cell system 1.

In the illustration in FIG. 3, a schematic representation of a cathode shut-off valve 20, 21 integrated into a portion of the fuel cell stack 3 shown in FIG. 2 can be seen in a possible embodiment variant according to the invention.

The cathode shut-off valve 20, 21 or the valve device 20, 21 has a valve body 101, which is arranged in a cavity of a portion of the fuel cell stack 3. The valve body 101 is arranged, at least in portions, along a flow direction of the (cathode) gas or (cathode) fluid flowing into or out of the cathode region 5, illustrated by an arrow P1 in FIG. 3, which is present in case of intended use, and against the flow direction of the cathode gas within the cavity of the portion of the fuel cell stack 3, in order to be movable, in particular linearly movable. Here, a cross section of the cavity of the portion of the fuel cell stack 3 or the region of the fuel cell stack 3 surrounding the cavity tapers in the direction against the flow direction of the cathode gas, so that the movement of the valve body 101 in the direction against the flow direction of the cathode gas is limited by the tapering cross section. A valve seat 120 of the cathode shut-off valve 20, 21 is formed by the portion of the fuel cell stack 3 in which the cross section tapers.

When the valve body 101 is in contact with the valve seat 120, in one embodiment when the valve body 101 is in contact with a sealing element 102 arranged in the region of the valve seat 120, for example in the form of an O-ring, as illustrated in FIG. 3, the cathode shut-off valve 20, 21 is located in a closed position, while the cathode shut-off valve 20, 21 is in an open position when the valve body 101 is not in contact with the valve seat 120 or when the valve body 101 is not in contact with the sealing element 102.

To guide the movement, in particular the opening or closing movement, of the valve body 101 within the fuel cell stack 3, the cathode shut-off valve 20, 21 also has a guide device 112 with one or more guide surfaces, which is or are designed to guide the movement of the valve body 101, in particular by the valve body 101 sliding along this or these as it moves.

The guide device 112 is mounted on an inner side of the portion of the fuel cell stack 1 surrounding the cavity by means of one or more, preferably three, fastening elements 106, in particular fin-like fastening elements 106, whereby the position of the guide device 112 within the fuel cell stack 1 is fixed. FIG. 4 shows a corresponding top view in the direction of the flow direction of the cathode gas onto the guide device 112 including the fastening elements 106.

The guide device 112 has a cylindrical portion which preferably extends parallel to the flow direction of the cathode gas, wherein an end of the cylindrical portion facing away from an inlet of the cathode shut-off valve 20, 21 can be closed in one embodiment, and in another embodiment, shown in FIG. 3, it may have a passage 105 through which any liquid that may be present, such as water, can flow away.

The valve body 101 has one or more projections which extend towards an outlet of the cathode shut-off valve 20, 21, wherein one of the projections, in particular a central projection, extends into the cavity formed by the cylindrical portion of the guide device 112, and another of the projections surrounds the end of the cylindrical portion of the guide device 112 facing the inlet of the cathode shut-off valve 20, 21.

The cathode shut-off valve 20, 21 is designed as a magnetically degressive valve, which in the normal case, in particular when the pressure difference between the pressure on the inlet side of the cathode shut-off valve 20, 21 and the pressure on the outlet side of the cathode shut-off valve 20, 21 is less than a predetermined threshold value, is held by magnetic forces in the closed position. The force with which the cathode shut-off valve 20, 21 is held in the closed position is comparatively large, wherein a closing force F for moving the cathode shut-off valve 20, 21 into the closed position again after opening the cathode shut-off valve 20, 21 decreases with an increase of the opening or distance D of the valve body 101 from the valve seat 120 or sealing element 102, as illustrated in the diagram in FIG. 5, in contrast to spring-loaded valves in which the closing force decreases with increasing opening.

For this purpose, the cathode shut-off valve 20, 21 has one or more magnets 104, preferably designed as permanent magnets, with north or south poles 104-1, 104-2, arranged in the region of the valve seat 120 or at a distance from the valve seat 120, wherein the valve body 101, at least in portions, in particular in one or more region(s) facing the magnet(s) 104 and/or in one or more region(s) close to the magnet(s) 104, in particular the closest region(s) 116, comprises a magnetizable material and/or a (permanent) magnet with the same polarity as the magnets 104. As a result, the valve body 101 is driven in the direction of the inlet of the cathode shut-off valve 20, 21 based on the magnetic forces occurring between the magnet 104 and the magnetizable material and/or the (permanent) magnet of the valve body 101.

In an optional embodiment, there is also a fixed (permanent) magnet 108, preferably mounted on the guide device 112, with north and south poles 108-1, 108-2 inside the cylindrical portion of the guide device 112 and one (permanent) magnet 107 mounted on the valve body 101 and movable therewith with north and south poles 107-1, 107-2 is provided, the polarity of which corresponds to that of the magnet 104, so that the attraction between the two magnets 107, 108 and thus the closing force further decreases with increasing opening of the cathode shut-off valve 20, 21.

On its end facing the inlet of the cathode shut-off valve 20, 21, the valve body 101 has a, in particular annular, recess or trough 110, with which, in particular in the case that the cathode shut-off valve 20, 21 is integrated on the outlet side of the cathode region 5, liquid, such as water, possibly escaping from the cathode region 5 can be collected. For this purpose, the cathode shut-off valve 20, 21 or the valve body 101 is preferably mounted within the fuel cell stack 3 in such a way that the exposed surface of the trough 110 points upwards when used as intended, so that by means of the trough 110 a liquid falling from above and striking the valve body 101 can be collected in the trough 110.

In one embodiment, the surface of the trough 110 is designed to be hydrophilic, as illustrated by the dashed lines marked with the reference number 103 in FIG. 3. In one embodiment, surfaces of undercuts 113 pointing in the direction of the outlet of the cathode shut-off valve 20, 21, which are provided on the side of the valve body 101 in the portion of the fuel cell stack 3 in which the valve device 20, 21 is integrated, are designed to be hydrophilic, as shown by the dashed lines 114.

Due to the hydrophilic design of the surface of the trough 110 and/or the surfaces of the undercuts 113, any liquid contained in the cathode gas, such as water, is collected at these locations and is thus at least temporarily removed from the rest of the fuel cell stack 3 or the fuel cell system 1. Even if ice forms in these regions due to this accumulation of water due to low temperatures, this has little or no influence on the operation of the cathode cut-off valve 20, 21, since this does not restrict in particular the mobility of the valve body 101, as would be the case if the valve body 101 freezes on the valve seat 120 or the sealing element 102.

To substantially prevent the valve body 101 from freezing on the valve seat 120 or the sealing element 102, a surface of the valve seat 120 and/or the sealing element 102 and/or a surface of the valve body 101, wherein the surface of the valve seat 120 and/or the sealing element 102 faces the surface of the valve body 101, as illustrated by the dashed line provided with the reference number 111, and/or the guide surface(s) and/or an end face of the guide device 112 facing the inlet of the cathode shut-off valve 20, 21 and/or portions of the valve body 101 facing the guide device 112 are designed to be hydrophobic, as illustrated by the dashed lines provided with the reference number 109, whereby the accumulation of liquid, in particular water, at these points can be at least largely prevented.

The hydrophobizing/hydrophilization of the above-mentioned regions or surfaces can be done, for example, by a) choosing an appropriate hydrophobic/hydrophilic material; b) polishing the respective surface to make it hydrophobic or roughening the respective surface for hydrophilization; c) plasma treatment of the respective surface; d) generating capillary forces by shaping, for example by forming lamellas on the respective surface.

A schematic view of a part of a fuel cell system in a possible embodiment according to the invention can now be seen in the illustration in FIG. 6.

In this embodiment, the fuel cell system 1 only has one cathode shut-off valve 20, 21 integrated into the fuel cell stack 3, in particular, for example, a passive, magnetically degressive cathode shut-off valve 21 illustrated in FIG. 3, which is arranged near the outlet of the cathode region 5.

In contrast, on the inlet side of the cathode region 5, preferably arranged in the supply air line 13 or integrated into another component of the fuel cell system 1, an active or actively controllable multi-way valve 204, in particular a 3/2-way valve, which functions as a cathode shut-off valve, is arranged.

In an embodiment not shown, the multi-way valve 204 is integrated into an air treatment unit (LAE) or humidifier unit such as the gas-gas humidifier 16 and is further integrated there with or in a usually provided humidifier bypass flap or control function.

The inlet of the multi-way valve 204 is connected to the supply air line 13. A first outlet of the multi-way valve 204 is connected to the inlet of the cathode region 5, wherein the flow path into the cathode region is blocked by blocking the first outlet of the multi-way valve 204. A second outlet of the multi-way valve 204 is connected to the exhaust air line 14 of the cathode region 5 downstream of the cathode shut-off valve 21 via a cathode bypass line 208, in which optionally, as illustrated in FIG. 6, a catalytic converter 206 can be provided.

The cathode shut-off valve 21 and the multi-way valve 204 integrated into the fuel cell stack 3 are in particular connected to one another via a gas jet or suction jet pump or jet pump 203, which can contain, for example, a Venturi nozzle or is formed from this and which is driven by the cathode gas flowing through the cathode bypass line 208 as a driving jet, which flows into a drive inlet of the gas jet pump 203. Here, a blow-off line 209 connected to the recirculation line 9, in particular to an outlet of a water separator 205 arranged in the recirculation line 9, is connected to a suction inlet of the gas jet pump 203 via a blow-off valve or purge valve 202 or purge/drain valve 202. Furthermore, a cathode branch line 207 connected to the outlet of the cathode region 5 upstream of the cathode shut-off valve 21 is connected to another suction inlet of the gas jet pump 203 via a cathode suction valve 201.

In this way, by switching the multi-way valve 204 to the second outlet for connecting the supply air line 13 to the exhaust air line 14 via the gas jet pump 203 and switching the cathode suction valve 201 into an open position, on the one hand, the cathode region 5, and by switching the multi-way valve 204 to the second outlet for connecting the supply air line 13 to the exhaust air line 14 via the gas jet pump 203 and switching the purge/drain valve 202 to an open position, on the other hand, the anode region 4 can be placed under negative pressure.

This means that any liquids that may be present, such as water, through or after evaporation at low pressure, as well as gases such as air, even at low temperatures, can be sucked out of the volume of the anode region 4 or the anode circuit as well as from the volume of the cathode region 5. Ideally, this suction is relatively uniform in order to avoid excessive pressure differences between the cathode region 5 and the anode region 4 and thus protect the membranes. In a fuel cell system 1 with two passive cathode shut-off valves 20, 21 on the inlet and outlet side, respectively, of the cathode region 5, this (suction and evaporation) function would not be available because one of the cathode shut-off valves 20, 21, in particular the cathode shut-off valve 20 on the inlet side, would always open again by drawing in.

In an embodiment not shown, the gas jet pump 203 can alternatively be integrated, preferably together with the multi-way valve 204, in a bypass of the air treatment unit (LAE) or humidifier unit, such as the gas-gas humidifier 16, and can also be integrated there with or in a usually provided humidifier bypass flap or control function. Here, the gas jet pump 203 can be driven as a driving jet by the gas flowing through the bypass, and the gas jet pump 203 can be switchably connected on the suction side to the cathode region 5 or the anode region 4 via a cathode suction valve 201 or a purge/drain valve 202 and corresponding lines, in order to be able to create a vacuum and empty them.

What is claimed is:

1. A fuel cell stack with a plurality of individual cells, wherein the individual cells have a common cathode region and a common anode region separated from the common cathode region,
wherein
at least one valve device is integrated for blocking the flow path into the cathode region and/or out of the cathode region.

2. The fuel cell stack according to claim 1,
wherein
the at least one valve device is designed to be integrated into at least one end plate.

3. The fuel cell stack according to claim 1,
wherein
the at least one valve device is designed as a normally closed valve device.

4. The fuel cell stack according to claim 3,
wherein
a valve body of the at least one valve device is held open against spring pressure and/or against magnetic, in particular permanent magnetic, forces with a sufficient volume flow through the cathode region.

5. The fuel cell stack according to claim 4,
wherein
the valve body is made of soft magnetic material, in particular as a rotating part, or contains a soft magnetic, in particular magnetizable material and/or a permanent magnet, wherein, in the region of the valve seat, at least one permanent magnet is arranged which is directly or indirectly magnetically operatively connected with the valve seat.

6. The fuel cell stack according to claim 4,
wherein
the valve body has an end facing an inlet of the at least one valve device, which has a, in particular annular, recess, wherein in particular the end of the valve body points upwards when used as intended.

7. The fuel cell stack according to claim 4,
wherein
the at least one valve device has a guide device with one or more guide surfaces, which is or are designed to guide an opening or closing movement of the valve body, wherein the guide device has a cylindrical portion, the valve body has at least one projection which extends in the direction of an outlet of the at least one valve device, wherein in particular a central projection of the at least one projection extends into a cavity formed through the cylindrical portion of the guide device and/or a projection of the at least one projection surrounds an end of the cylindrical portion of the guide device facing the inlet of the at least one valve device.

8. The fuel cell stack according to claim 7,
wherein
an end of the cylindrical portion of the guide device facing away from the inlet of the at least one valve device is closed or has a passage.

9. The fuel cell stack according to claim 5,
wherein
the at least one valve device has a fixed magnet, in particular mounted on the guide device, and a magnet mounted on the valve body movable together with the valve body, and a magnetic force between the fixed magnet and the magnet which is movable together with the valve body causes the fixed magnet and the magnet moving together with the valve body to attract each other.

10. The fuel cell stack according to claim 1,
wherein
the at least one valve device has regions with a hydrophobic surface, wherein
in particular a surface of the valve seat and/or of a sealing element arranged in a region of the valve seat and/or a surface of the valve body is designed to be hydrophobic, wherein the surface of the valve seat and/or of the sealing element faces the surface of the valve body, and/or
wherein a guide surface of the guide device and/or an end face of the guide device facing the inlet of the valve device and/or surface portions of the valve body facing the guide device are designed to be hydrophobic.

11. The fuel cell stack according to claim 1,
wherein
the at least one valve device has regions with a hydrophilic surface, wherein in particular a surface of the recess and/or a surface of an undercut pointing in the direction of the outlet of the valve device, which is provided on the side of the valve body in a portion of the fuel cell stack in which the valve device, is integrated, is designed to be hydrophilic.

12. The fuel cell stack according to claim 1,
wherein
a sealing element lying in the slipstream of the flow is arranged in the region of a valve seat.

13. The fuel cell stack according to claim 1,
wherein
at least one valve device is respectively formed on the upstream and downstream sides of the cathode region.

14. The fuel cell stack according to claim 13,
wherein
the two valve devices are designed as identical parts.

15. A fuel cell system, comprising a fuel cell stack according to claim 1,
wherein
the fuel cell stack comprises a valve device which is arranged downstream of an outlet of the cathode region and integrated into the fuel cell stack, which is designed in particular as a passive, magnetically degressive valve device, and the fuel cell system further has:
a multi-way valve arranged upstream of an inlet of the cathode region, and a gas jet pump with at least one suction inlet and a drive inlet, wherein an inlet of the multi-way valve is connected with a supply air line of the cathode region, a first outlet of the multi-way valve is connected with the inlet of the cathode region, and a second outlet of the multi-way valve is connected to the drive inlet of the gas jet pump,
a suction inlet of the at least one suction inlet of the gas jet pump is switchably connected with an outlet of the cathode region, in particular upstream of the valve device, in particular by means of a cathode suction valve, and/or another suction inlet of the at least one suction inlet of the gas jet pump is switchably connected to an outlet of the anode region, in particular via a recirculation line connected to the outlet of the anode region, in particular by means of a purge/drain valve.

16. The fuel cell system according to claim 15, in which the second outlet of the multi-way valve is connected to an exhaust air line of the cathode region via a cathode bypass line in which the gas jet pump is arranged.

17. The fuel cell system according to claim 15, in which the multi-way valve is integrated into a component of the fuel cell system-(H.

18. The fuel cell system according to claim 17, further comprising a gas/gas humidifier as the component, which is arranged upstream of the inlet of the cathode region, and
a gas/gas humidifier bypass line which is connected upstream of the gas/gas humidifier, to the supply air line, and upstream of the gas/gas humidifier to an exhaust air line of the cathode region, wherein
the multi-way valve is integrated into the gas/gas humidifier, in particular in a humidifier bypass flap of the gas/gas humidifier, and/or the gas jet pump is arranged in the gas/gas humidifier bypass line in such a way, that the second outlet of the multi-way valve is connected to the drive inlet of the gas jet pump.

19. The fuel cell stack according to claim 2,
wherein
the at least one valve device is designed as a normally closed valve device.

20. The fuel cell stack according to claim 5,
wherein
the valve body has an end facing an inlet of the at least one valve device, which has a, in particular annular, recess, wherein in particular the end of the valve body points upwards when used as intended.
